(19) United States
(12) Patent Application Publication
(10) Pub. No.: US 2024/0401721 A1
(43) Pub. Date: Dec. 5, 2024

(54) Multiple-Pipe Support Device

(71) Applicant: Mark Orihuela, Stockton, CA (US)

(72) Inventor: Mark Orihuela, Stockton, CA (US)

(21) Appl. No.: 18/408,654

(22) Filed: Jan. 10, 2024

Related U.S. Application Data
(60) Provisional application No. 63/470,245, filed on Jun. 1, 2023.

(51) Int. Cl. F16L 3/133; F16L 3/237

(52) U.S. Cl. CPC F16L 3/133; F16L 3/237

(57) ABSTRACT

A multiple-pipe support device is provided. The device is comprised of a body that receives at least two pipes such that the pipes can be routed and secured vertically using only one device. The body of the device is comprised of a first end and a second end. Both ends are comprised of at least one opening that allows at least one fastener such as, but not limited to. a bolt or a screw to be fastened through the body to create an opening between each fastener and each pipe support of each end. Then, a pipe can be routed vertically through the space between the first pipe support and fastener and a second pipe can be routed vertically through the space between the second pipe support and fastener.

### CROSS-REFERENCE TO RELATED APPLICATION

The present application claims priority to, and the benefit of, U.S. Provisional Application No. 63/470,245, which was filed on Jun. 1, 2023, and is incorporated herein by reference in its entirety.

### FIELD OF THE INVENTION

The present invention relates generally to the field of devices for routing and supporting pipes. More specifically, the present invention relates to a multiple-pipe support device that can be used to route and secure at least two pipes within a structure using a singular device. Accordingly, the present disclosure makes specific reference thereto. Nonetheless, it is to be appreciated that aspects of the present invention are also equally applicable to other like applications, devices, and methods of manufacture.

### BACKGROUND

In the construction of buildings and homes, one of the critical steps of construction is the routing of pipes. These pipes, essential for conveying water, gas, and sometimes electrical lines, need to be securely and efficiently installed within the structure. Traditionally, each pipe is routed and mounted within a structure using individual mounting hardware for each pipe. While this method has been widely adopted, it poses certain challenges.

More specifically, for each pipe installed, a separate piece of mounting hardware is required. This not only increases the overall quantity and cost of components needed but also demands more space within a structure for routing the pipes and accommodating the additional mounting hardware. In some areas of a structure, enough room may not exist to route and secure multiple pipes and multiple pieces of pipe mounting hardware.

Therefore, there exists a long-felt need in the art for a device that can be used to route and secure pipes within a structure. There also exists a long-felt need in the art for a multiple-pipe support device that can be used to route and secure multiple pipes within a structure. Further, there exists a long-felt need in the art for a multiple-pipe support device that can be used to route and secure multiple pipes within a structure wherein the device can route and secure multiple pipes using only a singular piece of hardware.

The subject matter disclosed and claimed herein, in one embodiment thereof, comprises a multiple-pipe support device. The device is comprised of a body that receives at least two pipes such that the pipes can be routed and secured vertically using only one device. The body of the device is comprised of a first end and a second end. Both ends are comprised of at least one opening that allows at least one fastener such as, but not limited to, a bolt or a screw to be fastened through the body to create an opening between each fastener and each pipe support of each end. Then, a pipe can be routed vertically through the space between the first pipe support and fastener and a second pipe can be routed vertically through the space between the second pipe support and fastener.

In this manner, the multiple-pipe support device of the present invention accomplishes all the foregoing objectives and provides a device that can be used to route and secure pipes within a structure. More specifically, the device can be used to route and secure multiple pipes within a structure wherein the device can route and secure multiple pipes using only a singular piece of hardware. This is advantageous as it saves space within a structure and reduces the cost of purchasing individual mounting hardware (and associated fasteners) for each pipe within a structure.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multiple-pipe support device. The device is comprised of a body that receives at least two pipes such that the pipes can be routed and secured vertically using only one device. The body of the device is comprised of a first end and a second end. The first end is comprised of at least one opening that allows at least one fastener such as, but not limited to, a bolt or a screw to be fastened through the body to secure the body to an element of a structure such as, but not limited to, a stud, a ceiling, etc.

The first end is also comprised of a first pipe support that receives a portion of a pipe. The pipe is further secured within an opening created by the first pipe and at least one fastener. The fastener can then be secured via a second fastener such as, but not limited to, a washer. In this manner, the pipe is secured between the first pipe support, fastener, and body such that it cannot be moved.

Similarly, the second end of the body is also comprised of a second pipe support. The support is preferably curved such that it receives a portion of a pipe. The pipe is further secured within an opening created by the second pipe support and at least one fastener. The fastener can then be secured via a second fastener such as, but not limited to, a washer. In this manner, the pipe is secured between the second pipe support, fastener, and body such that it cannot be moved. As a result, two pipes can be routed and secured via a singular device.

The present invention is also comprised of a method of using the device. First, a device is provided comprised of a body comprised of a first pipe support, a second pipe support, and at least two fasteners. Then, a first pipe can be placed between the first pipe support and a fastener that is secured through the body and first pipe support. Then, a second pipe can be placed between the second pipe support and a fastener that is secured through the body and second pipe support. Then, a fastener can be used to secure the body to a structure, surface, element, etc., via placing the fastener through an opening of the body and into the structure, surface, element, etc.

The present invention is also comprised of a second method of using the device. First, a device is provided comprised of a body comprised of a first pipe support, a second pipe support, and at least two fasteners. Then, a first pipe can be placed between the first pipe support and a fastener that is secured through the body and first pipe support. Then, the second pipe support can be rotated 180 degrees such that it is fully inside the body. Then, a second pipe can be placed between the second pipe support and a fastener that is secured through the body and second pipe support. Then, a fastener can be used to secure the body to a structure, surface, element, etc., via placing the fastener through an opening of the body and into the structure, surface, element, etc.

Accordingly, the multiple-pipe support device of the present invention is particularly advantageous as it provides a device that can be used to route and secure pipes within a structure. More specifically, the device can be used to route and secure multiple pipes within a structure wherein the device can route and secure multiple pipes using only a singular piece of hardware. This is advantageous as it saves space within a structure and reduces the cost of purchasing individual mounting hardware (and associated fasteners) for each pipe within a structure. In this manner, the multiple-pipe support device overcomes the limitations of existing methods and devices of routing and securing pipes known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top view of one potential embodiment of a multiple-pipe support device of the present invention in accordance with the disclosed architecture;

FIG. 2 illustrates a side view of one potential embodiment of a multiple-pipe support device of the present invention in accordance with the disclosed architecture;

FIG. 3 illustrates a top view of one potential embodiment of a multiple-pipe support device of the present invention in accordance with the disclosed architecture;

FIG. 4 illustrates a flowchart of a method of using one potential embodiment of a multiple-pipe support device of the present invention in accordance with the disclosed architecture; and

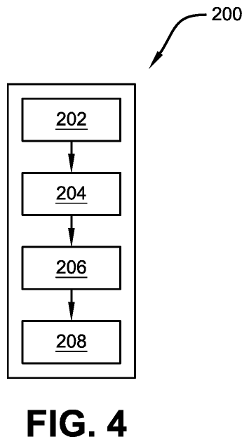

FIG. 5 illustrates a flowchart of a method of using one potential embodiment of a multiple-pipe support device of the present invention in accordance with the disclosed architecture.

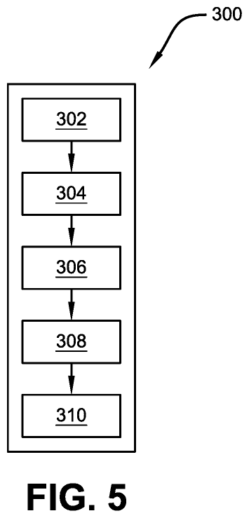

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can be used to route and secure pipes within a structure. There also exists a long-felt need in the art for a multiple-pipe support device that can be used to route and secure multiple pipes within a structure. Further, there exists a long-felt need in the art for a multiple-pipe support device that can be used to route and secure multiple pipes within a structure wherein the device can route and secure multiple pipes using only a singular piece of hardware.

The present invention, in one exemplary embodiment, is comprised of a multiple-pipe support device. The device is comprised of a body that receives at least two pipes such that the pipes can be routed and secured vertically using only one device. The body of the device is comprised of a first end and a second end, wherein the first end is comprised of at least one opening that allows at least one fastener such as, but not limited to, a bolt or a screw to be fastened through the body to secure the body to an element of a structure such as, but not limited to, a stud, a ceiling, etc.

The first end is also comprised of a first pipe support that receives a portion of a pipe. The pipe is further secured within an opening created by the first pipe and at least one fastener. The fastener can then be secured via a second fastener such as, but not limited to, a washer. In this manner, the pipe is secured between the first pipe support, fastener, and body such that it cannot be moved.

The second end of the body is also comprised of a second pipe support that is preferably curved such that it receives a portion of a pipe. The pipe is further secured within an opening created by the second pipe support and at least one fastener. The fastener can then be secured via a second fastener such as, but not limited to, a washer. In this manner, the pipe is secured between the second pipe support, fastener, and body such that it cannot be moved. As a result, two pipes can be routed and secured via a singular device.

The present invention is also comprised of a method of using the device. First, a device is provided comprised of a body comprised of a first pipe support, a second pipe support, and at least two fasteners. Then, a first pipe can be placed between the first pipe support and a fastener that is secured through the body and first pipe support. Then, a second pipe can be placed between the second pipe support and a fastener that is secured through the body and second pipe support. Then, a fastener can be used to secure the body to a structure, surface, element, etc., via placing the fastener through an opening of the body and into the structure, surface, element, etc.

The present invention is also comprised of a second method of using the device. First, a device is provided comprised of a body comprised of a first pipe support, a second pipe support, and at least two fasteners. Then, a first pipe can be placed between the first pipe support and a fastener that is secured through the body and first pipe support. Then, the second pipe support can be rotated 180 degrees such that it is fully inside the body. Then, a second pipe can be placed between the second pipe support and a fastener that is secured through the body and second pipe support. Then, a fastener can be used to secure the body to a structure, surface, element, etc., via placing the fastener through an opening of the body and into the structure, surface, element, etc.

Accordingly, the multiple-pipe support device of the present invention is particularly advantageous as it provides a device that can be used to route and secure pipes within a structure. More specifically, the device can be used to route and secure multiple pipes within a structure wherein the device can route and secure multiple pipes using only a singular piece of hardware. This is advantageous as it saves space within a structure and reduces the cost of purchasing individual mounting hardware (and associated fasteners) for each pipe within a structure. In this manner, the multiple-pipe support device overcomes the limitations of existing methods and devices of routing and securing pipes known in the art.

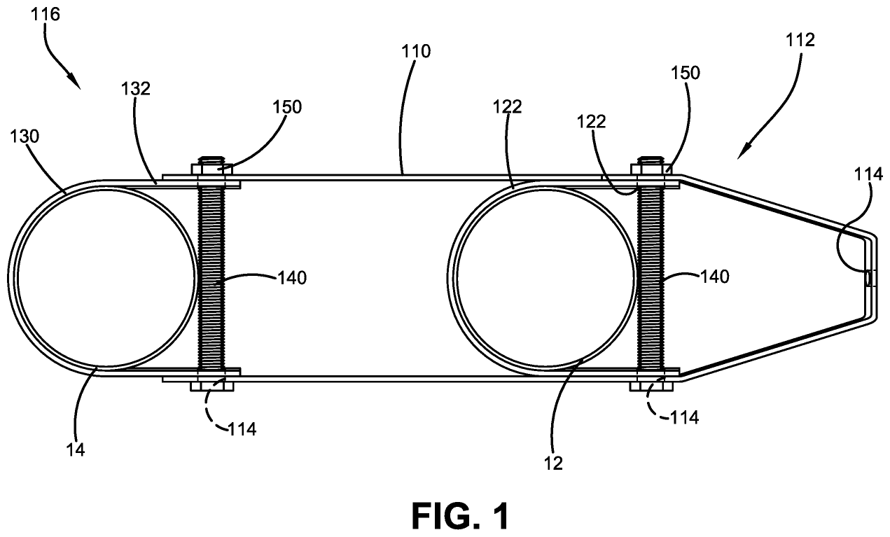

Referring initially to the drawings, FIG. 1 illustrates a top view of one potential embodiment of a multiple-pipe support device 100 of the present invention in accordance with the disclosed architecture. The device 100 is comprised of a body 110 that receives at least two pipes 12, 14 such that the pipes 12, 14 can be routed and secured vertically using only one device 100. The device 100 is preferably made from a metal material but may be made of any material in different embodiments.

The body 110 of the device 100 is comprised of a first end 112 and a second end 116. The first end 112 is comprised of at least one opening 114. The opening 114 allows at least one fastener such as, but not limited to, a bolt or a screw to be fastened through the body 110 to secure the body 110 to an element of a structure such as, but not limited to, a stud, a ceiling, etc. However, the opening 114 may be positioned anywhere on the body 110 in different embodiments to allow the device 100 to be secured to a plurality of structures in a plurality of arrangements.

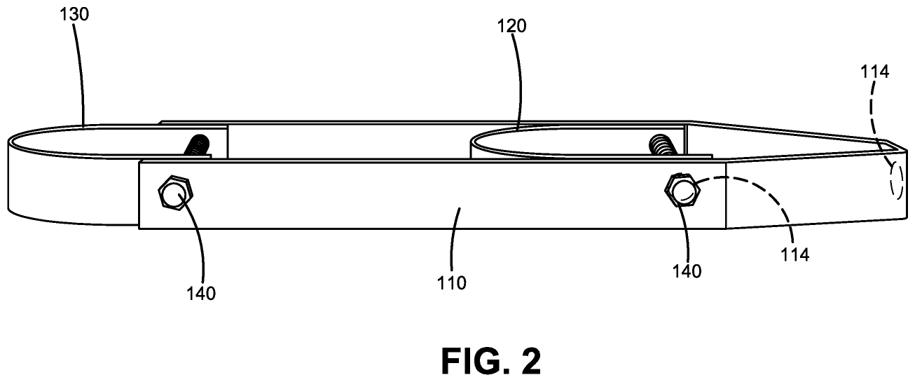

The first end 112 is also comprised of a first pipe support 120. The support 120 is preferably curved such that it receives a portion of a pipe 12. The pipe 12 is further secured within an opening 124 created by the first pipe support 120 and at least one fastener 140. The fastener 140 is preferably a threaded bolt that travels through at least one opening 114 of the body 110 (as seen in FIG. 2) and at least one opening 122 of the support 120. The fastener 140 can then be secured via a second fastener 150 such as, but not limited to, a washer. In this manner, the pipe 12 is secured between the first pipe support 120, fastener 140, and body 110 such that it cannot be moved.

The second end 116 is also comprised of a second pipe support 130. The support 130 is preferably curved such that it receives a portion of a pipe 14. The pipe 14 is further secured within an opening 134 created by the second pipe support 130 and at least one fastener 140. The fastener 140 is preferably a threaded bolt that travels through at least one opening 114 of the body 110 and at least one opening 132 of the support 130. The fastener 140 can then be secured via a second fastener 150 such as, but not limited to, a washer. In this manner, the pipe 14 is secured between the second pipe support 130, fastener 140, and body 110 such that it cannot be moved. As a result, two pipes 12, 14 can be routed and secured via a singular device 100.

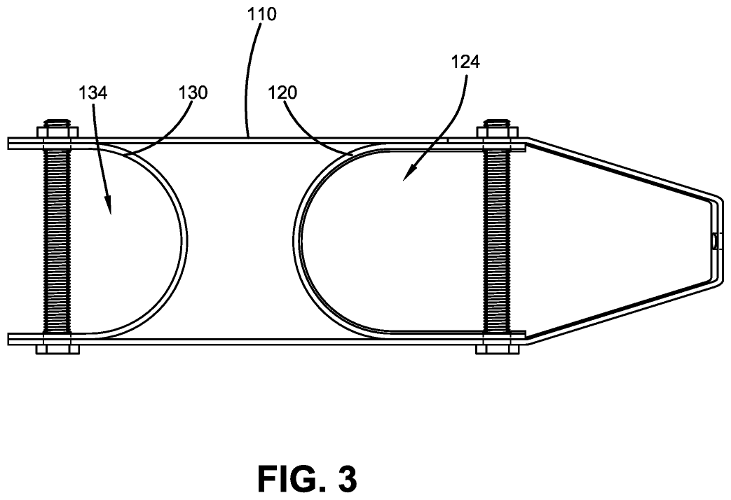

It should be noted that in one embodiment the second pipe support 130 may rotate around the fastener 140 180 degrees, as seen in FIG. 3. This allows the second pipe 14 to be routed closer to the first pipe 12 if needed.

The present invention is also comprised of a method of using 200 the device 100. First, a device 100 is provided comprised of a body 110 comprised of a first pipe support 120, a second pipe support 130, and at least two fasteners 140 [Step 202]. Then, a first pipe 12 can be placed between the first pipe support 120 and a fastener 140 that is secured through the body 110 and first pipe support 120 [Step 204]. Then, a second pipe 14 can be placed between the second pipe support 130 and a fastener 140 that is secured through the body 110 and second pipe support 130 [Step 206]. Then, a fastener can be used to secure the body 110 to a structure, surface, element, etc., via placing the fastener through an opening 114 of the body 110 and into the structure, surface, clement, etc. [Step 208].

The present invention is also comprised of a second method of using 300 the device 100. First, a device 100 is provided comprised of a body 110 comprised of a first pipe support 120, a second pipe support 130, and at least two fasteners 140 [Step 302]. Then, a first pipe 12 can be placed between the first pipe support 120 and a fastener 140 that is secured through the body 110 and first pipe support 120 [Step 304]. Then, the second pipe support 130 can be rotated 180 degrees such that it is fully inside the body 110, as seen in FIG. 3 [Step 306]. Then, a second pipe 14 can be placed between the second pipe support 130 and a fastener 140 that is secured through the body 110 and second pipe support 130 [Step 308]. Then, a fastener can be used to secure the body 110 to a structure, surface, element, etc., via placing the fastener through an opening 114 of the body 110 and into the structure, surface, element, etc. [Step 310].

It should be appreciated that the device 100 can be oriented to route and secure pipes horizontally or vertically in different embodiments.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multiple-pipe support device” and “device” are interchangeable and refer to the multiple-pipe support device 100 of the present invention.

Notwithstanding the foregoing, the multiple-pipe support device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the multiple-pipe support device 100 as shown in the FIGS. are for illustrative purposes only, and that many other sizes and shapes of the multiple-pipe support device 100 are well within the scope of the present disclosure. Although the dimensions of the multiple-pipe support device 100 are important design parameters for user convenience, the multiple-pipe support device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multiple-pipe support device comprising:
a body comprised of a first opening, a first fastener, a second fastener, a first pipe support, and a second pipe support.

2. The multiple-pipe support device of claim 1, wherein the first fastener is comprised of a threaded bolt.

3. The multiple-pipe support device of claim 1, wherein the second fastener is comprised of a threaded bolt.

4. The multiple-pipe support device of claim 1, wherein the first fastener secures the first pipe support to the body.

5. The multiple-pipe support device of claim 1, wherein the second fastener secures the second pipe support to the body.

6. The multiple-pipe support device of claim 1, wherein the second pipe support can rotate 180 degrees around the second fastener.

7. The multiple-pipe support device of claim 1, wherein the first pipe support is positioned at a first end of the body.

8. The multiple-pipe support device of claim 1, wherein the second pipe support is positioned at second end of the body.

9. The multiple-pipe support device of claim 1, wherein the first fastener and the first pipe support form a second opening.

10. The multiple-pipe support device of claim 1, wherein the second fastener and the second pipe support form a third opening.

11. A multiple-pipe support device comprising:
a body comprised of a first end and a second end;
a first opening positioned on the body at the first end;
a second opening positioned on the body;
a third opening positioned on the body;
a first fastener;
a second fastener;
a first pipe support comprised of a fourth opening; and
a second pipe support comprised of a fifth opening.

12. The multiple-pipe support device of claim 11, wherein the second fastener is positioned through the third opening and the fifth opening.

13. The multiple-pipe support device of claim 11, wherein the first fastener is positioned through the second opening and the fourth opening.

14. The multiple-pipe support device of claim 11, wherein the first fastener is comprised of a threaded bolt.

15. The multiple-pipe support device of claim 11, wherein the second fastener is comprised of a threaded bolt.

16. The multiple-pipe support device of claim 11, wherein the first fastener and the first pipe support form a sixth opening.

17. The multiple-pipe support device of claim 11, wherein the second fastener and the second pipe support form a seventh opening.

18. A method of using a multiple-pipe support device, the method comprising the following steps:
providing a multiple-pipe support device comprised of a body comprised of a first fastener, a second fastener, a first pipe support member, and a second pipe support member;
placing a first pipe between the first pipe support and the first fastener;
placing a second pipe between the second pipe support and the second fastener;
placing a third fastener through an opening of the body to secure the body to a surface.

19. The method of using a multiple-pipe support device of claim 18, wherein the first pipe is positioned vertically between the first pipe support member and the first fastener.

20. The method of using a multiple-pipe support device of claim 18, wherein the second pipe is positioned vertically between the second pipe support member and the second fastener.
